(19) United States
(12) Patent Application Publication
(10) Pub. No.: US 2015/0078260 A1
(43) Pub. Date: Mar. 19, 2015

(54) PARALLEL RESOURCE MANAGEMENT IN WHITE SPACE BANDS USING TRANSMIT POWER CONTROL AND CHANNEL SET ASSIGNMENT

(71) Applicant: Fujitsu Limited, Kawasaki-shi (JP)

(72) Inventors: Golnaz Farhadi, Sunnyvale, CA (US); Karim Khalil, Columbus, OH (US)

(73) Assignee: Fujitsu Limited, Kawasaki-shi (JP)

(21) Appl. No.: 14/026,935

(22) Filed: Sep. 13, 2013

(51) Int. Cl. H04W 52/24; H04W 16/14; H04W 24/02

(52) U.S. Cl. CPC H04W 52/243; H04W 24/02; H04W 16/14
USPC 370/329

(57) ABSTRACT

A method and system for parallel resource management in white space bands may use transmit power control and channel set assignment. Channel sets and corresponding network sets for each of L power levels may be assigned for N networks sharing K number of channels. The input may be location information for each of the N networks. The output may be updated channel sets and corresponding network sets for each of the L power levels. The method may assign maximum networks to channel sets with larger power values. The network sets may be constructed such that a number of channels in a corresponding channel set is larger than a maximum node degree of a corresponding interference graph. The method may further take into account re-use possibilities for channels among networks and may accordingly increase spectrum utilization.

### BACKGROUND

1. Field of the Disclosure

This disclosure relates generally to communication networks and, in particular, to parallel resource management in white space bands using transmit power control and channel assignment.

2. Description of the Related Art

As the number and types of wireless networks proliferate, and the amount of communication carried thereon increases, it has become increasingly desirable to manage networks comprising wireless networks of differing wireless access technologies, power limitations, frequency limitations, and other differences. Management of such heterogeneous networks may become increasingly complicated because of the shared nature of white space bands. While some solutions have been offered for managing coexistence in white space bands, maximization of spectrum re-use as well as spectrum utilization while avoiding interference remains a challenge.

### SUMMARY

In one aspect, a disclosed method for parallel resource management in white space bands includes receiving location information for N wireless networks sharing K channels in white space bands having L permissible power levels, where N, K, and L are integers greater than 1. The method may include generating, for each of the L power levels, an interference graph of the N wireless networks, the interference graph comprising nodes each corresponding to a wireless network and edges each corresponding to interference between two nodes. A number of edges at each node may represent a node degree. The method may include initializing channel sets corresponding to the L power levels, beginning with channels having maximum power levels. The method may further include initializing network sets corresponding to the L power levels, including maximizing a number of networks in a maximum power network set corresponding to a maximum power level, and emptying network sets other than the maximum power network set. The method may also include updating the channel sets and network sets. A number of channels in a channel set corresponding to a network set may be greater than a maximum node degree of the interference graph for a corresponding power level.

Additional disclosed aspects for parallel resource management in white space bands include an article of manufacture comprising a non-transitory, computer-readable medium, and computer executable instructions stored on the computer-readable medium. A further aspect includes a management system for parallel resource management in white space bands comprising a memory, a processor coupled to the memory, a network interface, and computer executable instructions stored on the memory.

The object and advantages of the embodiments will be realized and achieved at least by the elements, features, and combinations particularly pointed out in the claims.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram of selected elements of an embodiment of a network for parallel resource management in white space bands;

FIG. 2 is a block diagram of selected elements of an embodiment of a management system for parallel resource management in white space bands;

FIGS. 3A, 3B, and 3C show selected elements of embodiments of interference graphs;

FIG. 4 is a flow chart of selected elements of an embodiment of a method for parallel resource management in white space bands;

FIG. 5 is a flow chart of selected elements of an embodiment of a method for parallel resource management in white space bands; and

FIGS. 6A and 6B show selected elements of embodiments of interference graphs.

### DESCRIPTION OF PARTICULAR EMBODIMENT(S)

Wireless network providers are demanding more spectra to meet unprecedented growth in mobile data traffic. Despite this fact, the spectrum allocated in many bands (e.g. TV bands or federally allocated bands) may remain heavily underutilized. Regulatory entities around the world have been developing policies to enable access to the unused portions of the band (referred to as “white space bands”) when incumbents are not present. At a given location, channels in white space bands may be available for unlicensed access using different power levels, for example, depending on the proximity of incumbents. In order to exploit the additional resource provided by white space bands, multiple networks that share this spectra may be deployed, which may represent a valuable opportunity for wireless network providers.

However, without coordination of access to the white space bands, networks located in close proximity of each other may interfere, thus leading to poor performance. In addition, governed by white space regulations, each network may be allowed to transmit with only one transmit power level, regardless of the number of channels assigned.

As will be described in further detail herein, computational methods (e.g., algorithms) having polynomial-time complexity for heterogeneous coexistence management in white space bands have been developed. The computational methods presented herein may enable coordination of spectrum allocation and power levels such that harmful interference among neighboring networks is avoided, while utilization of individual channels in the white space bands is maximized. The computational methods described herein may split the networks and available white space band channels into disjoint sets with the objective of increasing spectrum re-use and utilization of channels with larger power levels. The disjoint sets may correspond to specific permissible power levels. Then, a channel assignment is performed in parallel for each network set from its corresponding channel set.

In the following description, details are set forth by way of example to facilitate discussion of the disclosed subject matter. It should be apparent to a person of ordinary skill in the field, however, that the disclosed embodiments are exemplary and not exhaustive of all possible embodiments.

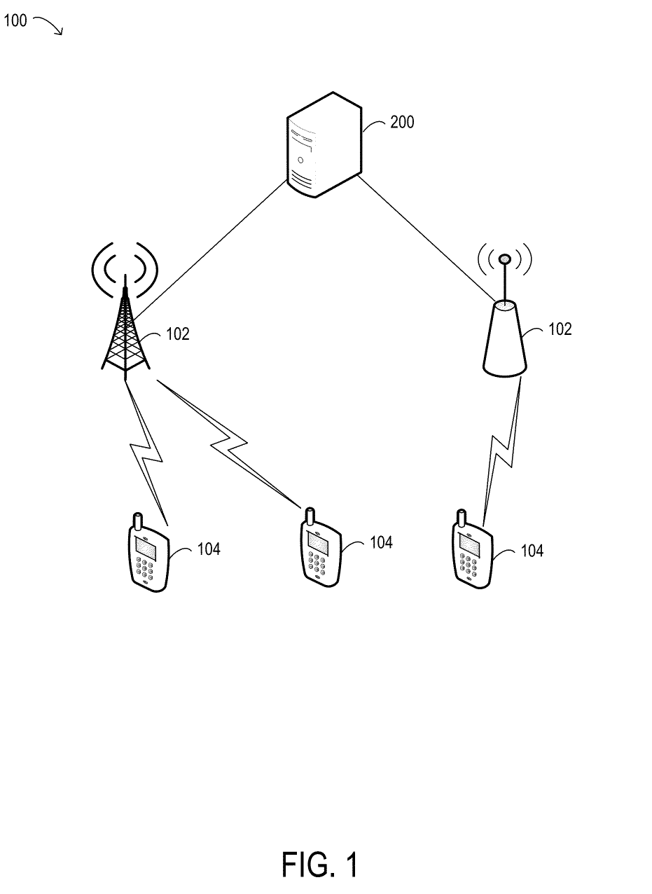

Particular embodiments and their advantages are best understood by reference to FIGS. 1 through 6, wherein like numbers are used to indicate like and corresponding parts.

Turning now to the drawings, FIG. 1 is a block diagram showing selected elements of an embodiment of network 100 for managing coexistence in white space bands, in accordance with certain embodiments of the present disclosure. In some embodiments, network 100 may include wireless networks 102, user equipment 104, and management system 200 communicatively coupled to wireless networks 102. As shown in FIG. 1, management system 200 may be in fixed communication with wireless networks 102 using galvanic and/or optical media (not shown), for example. Wireless networks 102 may, in turn, provide wireless signals for enabling network access by user equipment 104 to allow communication by user equipment 104 across wireless networks 102. As will be described herein, management system 200 may be configured to manage resources (e.g., channel assignments and/or power levels) to enable each of wireless networks 102 to operate in parallel while utilizing white space bands.

In some embodiments, wireless network 102 may be an access point to a communication network, the access point configured to allow user equipment 102 to communicate over the communication network. In some embodiments, each wireless network 102 shares substantially the same spectrum band as other wireless networks 102, while potentially operating on a different wireless access technology (e.g., IEEE 802.11, IEEE 802.22, LTE, etc.). Further, each wireless network 102 may be owned and/or operated by a different operator. For example, system 100 may include four wireless networks 102, including two LTE transmission towers, and two 802.22 wireless access points. In the same or alternative configurations, system 100 may include, more, fewer, or different configurations of wireless networks 102 without departing from the scope of the present disclosure.

In some embodiments, user equipment 104 may be an electronic device and/or combination of electronic devices configured to communicate and/or facilitate communication over any or all of the wireless networks 102. For example, user equipment 104 may be a cellular telephone, tablet computer, laptop computer, network of other user equipment 104, and/or other appropriate electronic device may be configured to transmit and/or receive data over wireless network 102.

In operation of network 100, white space bands may provide additional resources for wireless networks 102 to meet the increasing demand for mobile data traffic. Because of the scarcity of the spectrum and growing interest in offloading data traffic over white space bands, management system 200 may be enabled to control interference among neighbor networks and to increase resource (i.e., channel and/or power) utilization. White space bands may provide additional spectra with different power levels (e.g., in the TV band) for some channels depending on the activity of incumbents. In order to reuse spectrum and to better utilize additional power levels on some channels, orthogonal channel assignment may be provided along with power control, subject to regulatory constraints.

In certain cases where a number of available channels is constrained to a few channels, orthogonal sharing in time domain may be solved using a linear algorithm that may be efficiently solved. In situations where time sharing is not feasible, the complexity of the corresponding integer optimization problem may grow exponentially with the number of networks, available channels, and/or power levels and may result in a computationally intractable problem. Such a solution would need to assign channel(s) with a certain power level to a subset of networks. However, as given by current white space regulations, a network may only transmit with one power level when operating in white space bands, regardless of the number of channels used, which may result in spectral inefficiency and poor utilization of available channels.

As disclosed herein, an algorithm for parallel resource management in white space bands may generate disjoint sets of networks and channels using heuristics aimed at increasing overall resource utilization. The algorithm(s) disclosed herein may have polynomial-time complexity and may thus be solved efficiently. The channels in each channel set, which represents a permissible power level, may be allocated to the networks in the corresponding network set. Furthermore, these sets may be constructed such that a cardinality of a channel set is greater than a maximum node degree of an interference graph for a corresponding network set. Then, various channel assignment algorithms may be used in parallel for each network-channel set to allocate specific channels to networks. Hence, the algorithm disclosed herein may achieve a joint power control and channel assignment solution in polynomial-time complexity.

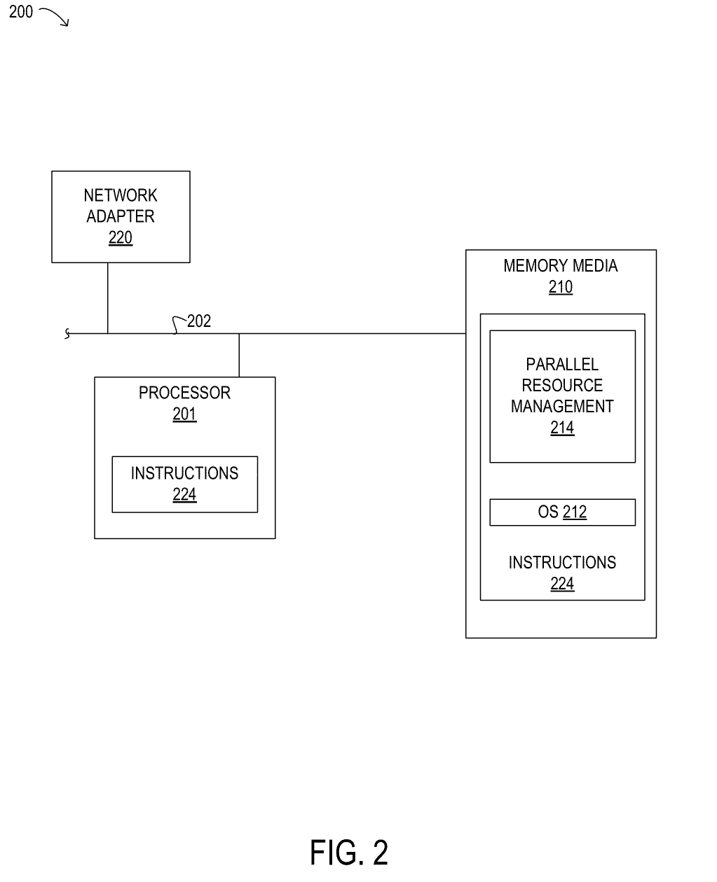

Referring now to FIG. 2, a block diagram illustrates selected elements of an embodiment of management system 200 for parallel white space resource management according to the present disclosure. In the embodiment depicted in FIG. 2, management system 200 includes processor 201 coupled via shared bus 202 to storage media collectively identified as memory media 210. Management system 200, as depicted in FIG. 2, further includes network adapter 220 that interfaces management system 200 to a network, such as portions of network 100, including wireless networks 102 (see FIG. 1).

In FIG. 2, memory media 210 may comprise persistent and volatile media, fixed and removable media, and magnetic and semiconductor media. Memory media 210 is operable to store instructions, data, or both. Memory media 210 as shown includes sets or sequences of instructions 224, namely, an operating system 212 and parallel resource management 214. Operating system 212 may be a UNIX or UNIX-like operating system, a Windows® family operating system, or another suitable operating system. Instructions 224 may also reside, completely or at least partially, within processor 201 during execution thereof. It is further noted that processor 201 may be configured to receive instructions 224 from memory media 210 via shared bus 202. As described herein, parallel resource management 214 may represent instructions and/or code for implementing various algorithms according to the present disclosure.

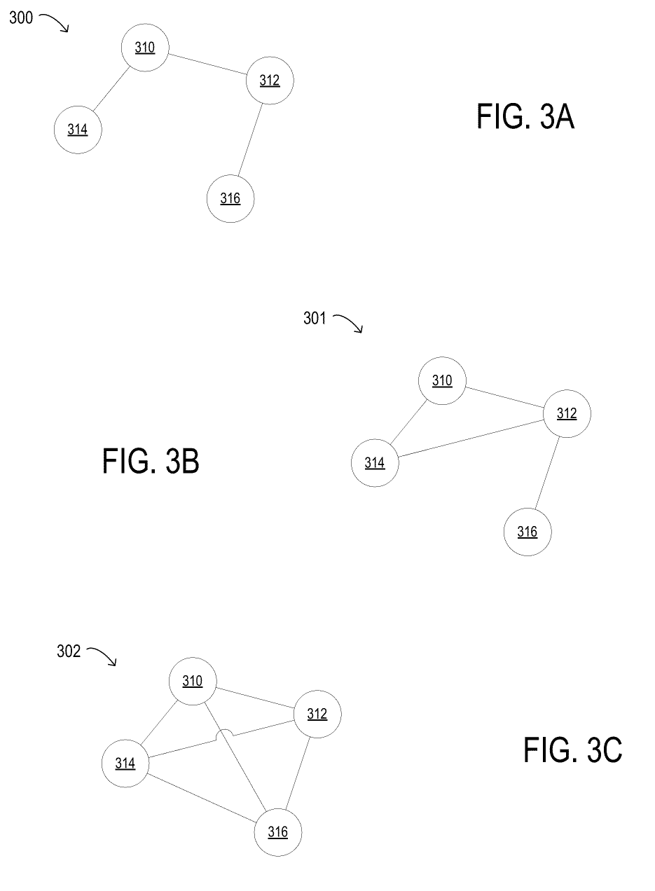

Turning now to FIGS. 3A-3C, a system model for an area where N networks share K white space channels for L permissible power levels is illustrated in the form of interference graphs 300, 301, and 302, where N=4 and L=3. In FIGS. 3A, 3B, and 3C, respective interference graphs 300, 301, and 302 may each represent a network topology at a different power level. In interference graphs 300, 301, and 302, the network nodes (circles) represent different networks and edges between nodes (lines) are present when two networks interfere with one another. In one interference graph, it is assumed that all network nodes transmit at substantially the same power level. In FIGS. 3A-3C, an exemplary embodiment of four network nodes 310, 312, 314, and 316 is shown for descriptive clarity. It will be understood that, in different embodiments, interference graphs, as described herein, may have different numbers of network nodes and edges.

In interference graph 300 of FIG. 3A, network node 310 may interfere with network nodes 312 and 314, while network node 312 also interferes with network node 316. In interference graph 301 of FIG. 3B, all the edges in interference graph 300 are present, with network node 314 additionally interfering with network node 312. In interference graph 302 of FIG. 3C, all the edges in interference graph 301 are present, with network node 316 additionally interfering with network nodes 310 and 314. As shown in FIGS. 3A-3C, the power level increases from a first power level for interference graph 300 to a second power level for interference graph 301 to a third power level for interference graph 302. Thus, for larger power levels, the interference graph may become denser and may indicate fewer opportunities for spectrum re-use.

In each of interference graphs 300, 301, and 302, a “node degree” may be defined as a number of edges per network node. Accordingly, the node degrees for interference graphs 300, 301, and 302 are given in Table 1.

TABLE 1
Node degrees for interference graphs 300, 301,
and 302 in respective FIGS. 3A, 3B, and 3C.

| Interference Graph | Node 310 | Node 312 | Node 314 | Node 316 |
|---|---|---|---|---|
| 300 | 2 | 2 | 1 | 1 |
| 301 | 2 | 3 | 2 | 1 |
| 302 | 3 | 3 | 3 | 3 |

Next, a “node degree change” may be defined as the change in node degree for a given network node between a previous power level and a current power level. The node degree change variable (Delta_l for power level l with respect to a previous power level l−1) may reflect whether a network has a higher chance of re-using the channels with smaller power level. A smaller value for Delta_l implies smaller chances of re-use with decreasing power level and, therefore, suggests that a larger power level may desirably be used for a given network, when possible. Conversely, a larger value for Delta_l implies a sparser interference graph with decreasing power level and, hence, suggests more chances of spectrum re-use with a lower power level. Accordingly, Delta_l, given in Table 2 for interference graphs 300, 301, and 302, is utilized to construct channel and network sets.

TABLE 2
Node degree change (Delta_l) for interference graphs
301 and 302 in respective FIGS. 3A, 3B, and 3C.

| Interference Graph | Node 310 | Node 312 | Node 314 | Node 316 |
|---|---|---|---|---|
| 301 (Delta_2) | 0 | 1 | 1 | 0 |
| 302 (Delta_3) | 1 | 0 | 1 | 2 |

It is further assumed that a total number of channels available is greater than a maximum node degree of an interference graph corresponding to the smallest power level (I_{—}1). Furthermore, at a given power value (p_l), the algorithm enforces the number of channels in a channel set (S_l) to be greater than a maximum node degree of an interference graph (G_l) comprising the networks in network set (N_l). This update design metric may guarantee an integer channel assignment solution with only one power level across all channels.

One embodiment of an algorithm for parallel resource management in white space bands will now be described in detail. Various notations and the corresponding definitions are given in Table 3 below.

| Notation | Definition |
|---|---|
| p_l | a power value for power level l |
| S_l | a set of channels (from the available channels) that may operate with maximum |
| | power value p_l |
| N_l | a set of networks to which channels from the channel set S_l are assigned |
| N | a set of all networks, such that after constructing the network sets N_1 U . . . U |
| | N_L = N |
| I_l | an interference graph where the nodes denote the networks and the edges reflect |
| | whether two networks interfere or not, assuming all nodes transmit at a maximum power |
| | level p_l. |
| G_l | An interference graph at power level p_l corresponding to networks set N_l |
| Delta_l | a node degree change for a graph at a power level (I_l) with respect to the graph |
| | at a previous power level (I_{l−1}) |
| \delta_l | a maximum node degree in graph G_l |

The algorithm described herein may have a polynomial-time complexity of O(K L² N³). An inner loop may iterate over values of Delta_l up to a maximum possible node degree change, N−1, and has maximum L iterations. The channel set updates may iterate up to a maximum (L−1)*K (total number of channels). Checking the re-use pairs may have O(N²) complexity. For the channel and network sets obtained, a desired channel assignment algorithm (not described in detail herein) may be executed in parallel to distribute the channels from each channel set to the corresponding network set. For example, the channel assignment algorithm may be based on a greedy graph coloring and/or another algorithm having polynomial-time complexity. Thus, the complexity for the overall joint power control and channel assignment solution described herein may be polynomial.

The algorithm described herein to split the channels and networks may receive as input at least identities and location information for N networks. In certain embodiments, the algorithms and methods described herein may be implemented by a white space database manager, such that a white space database may suggest the list of channels with the recommended power levels to each network, corresponding to the output of the methods described herein. Such a service may be expressly permitted by certain FCC regulations and may be supported by standards such as IEEE 802.19.1. Additionally, a central entity splitting the networks and channels may further execute a channel assignment algorithm (not described in detail herein) and may assign orthogonal channels with corresponding power levels to each network, based on the network sets and channel sets generated.

In a first step, the algorithm may comprise splitting the available channels into disjoint channels sets S_l where each channel in S_l may transmit at a maximum power level corresponding to power value p_l. As noted above with respect to FIGS. 3A-3C, for each power level l, an interference graph, G_l, may be constructed under the assumption that an operating frequency of the lowest available spectral band is used, such that G_l represents the most conservative graph in terms of bandwidth for a given power level.

In a second step, the algorithm may comprise splitting the available networks into disjoint sets where a network in network set N_l may be assigned channels from set S_{—}1. It is noted that a network in network set N_l may only be assigned channels from a single channel set S_l to comply with the white space regulations, which would require reducing a larger power level from channels in different channel sets when aggregating such channels. Furthermore, network set N_l may be constructed such that a number of channels in S_l is greater than a value for \delta_{—}1 for a given graph G_l. From graph coloring theory, this condition ensures an integer channel assignment solution to the algorithm.

One objective of the algorithm may be to first utilize the channels with larger power levels in as many networks as possible, and then to increase spectrum re-use. Therefore, networks are included in network set N_l′ (corresponding to a larger power level p_l′) as long as there exist enough channels in channel set S_l′ to assign to these networks. Then, network sets at lower power levels may be updated. Since these lower power network sets may have lower density interference graphs, they may provide more re-use options for given channels.

The heuristic approach used in the algorithm is motivated by the following observations:
using larger power (for substantially the same bandwidth) provides larger signal-to-noise ratio (SNR) and thus may improve the achievable throughput; and
using larger bandwidth (i.e., aggregation of more than one channel with substantially the same power level) may improve the achievable throughput.

However, using larger power level with smaller bandwidth (e.g., one white space channel) may achieve a better throughput than using a smaller power level with larger bandwidth (e.g., aggregation of two channels), because the maximum transmit power is limited to the lowest permissible power level regardless of the number of channels that may be aggregated.

Accordingly, certain design criteria may be applied to the algorithm. For one, channel sets may be constructed starting with channel sets including any channel having maximum power level p_l. Also, network sets may be construed starting with networks in larger power levels and particularly including networks with smaller Delta_l values, because such networks will have a smaller chance of channel re-use with the lower power level. As such, in order to increase utilization of power resources, these networks will be included in N_l as long as enough channels are available in S_l. Furthermore, channel sets may be updated when not enough channels are available in S_{—}1 to include in any remaining networks, with Delta_{—}2 taking any values from 0, 1, . . . , N−1. According to the channel set construction criteria, channel sets may be updated by moving one channel at a time from the channel set corresponding to the largest power value, p_k, where k may take a value L, L−1, . . . , 2, to the channel set having p_{k−1}.

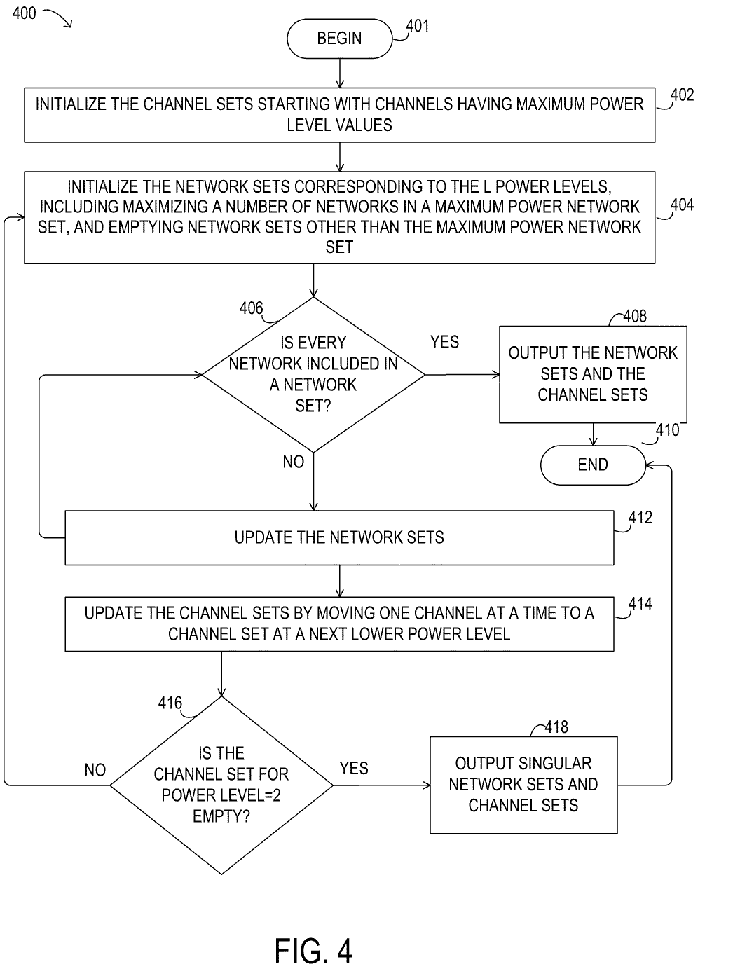

Turning now to FIG. 4, a block diagram of selected elements of an embodiment of method 400 for parallel white space resource management is shown in flow chart format. As noted above, method 400 may be used for locations where N networks share K white space channels, with some channels having different power levels, up to L power levels. Method 400 may be performed by management system 200 and may represent operations performed by parallel resource management 214 (see FIGS. 1 and 2). It is noted that certain operations depicted in method 400 may be rearranged or omitted, as desired.

Method 400 may begin at operation 401. In some embodiments, N number of networks and their respective locations may be identified during (or prior to) operation 401. For example, management system 200 may receive the identities and locations of the N number of networks and then output corresponding network sets and channel sets. The channel sets may be initialized (operation 402) starting with channels having maximum power level values. The channel sets may be initialized as S_l={set of channels with maximum power level p_l}, where l=1, 2, . . . , L. The network sets corresponding to the L power levels may be initialized (operation 404) including maximizing a number of networks in a maximum power network set, and emptying network sets other than the maximum power network set. The maximum power network set corresponds to the maximum power level. The network sets N_{—}1, . . . , N_{L−1} may initially be empty to fulfill the objective of first utilizing channels with the largest power level in as many networks as possible. Therefore, as many networks/re-use pairs (pairs of networks that are not neighbors and hence may re-use the same assigned channel) as possible may be included in N_L, such that the corresponding graph G_L has a node degree \delta_L=0 (i.e., graph G_L is a disconnected graph). When selecting one from multiple networks/re-use pairs is required, the network with minimum Delta_L along with its re-use pairs, if any, may be included in N_L. Thus, by having at least one channel in S_L, networks in N_L will get a channel assigned. For empty network sets, \delta_l=−1 may be initially defined, which may be used to evaluate the condition to add more networks to a given network set N_l according to the available channels with power level p_l.

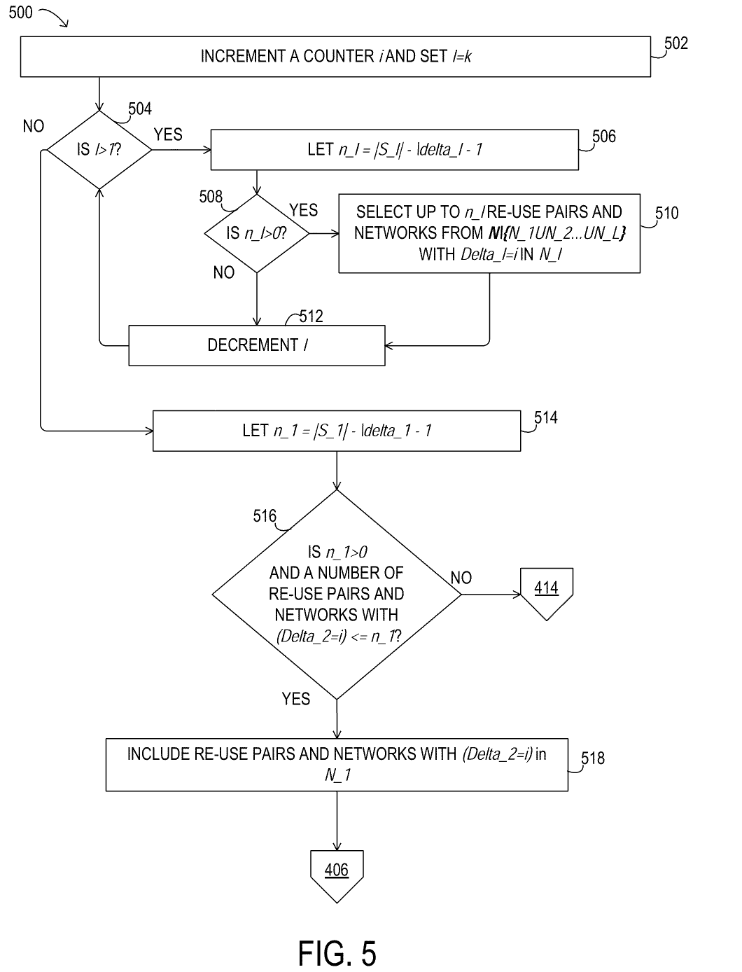

Next in method 400, a decision may be made whether every network is included in a network set (operation 406). When the result of operation 406 is YES, the network sets and the channel sets may be output (operation 408) and method 400 may end (operation 410). When the result of operation 406 is NO, the network sets may be updated (operation 412, see also FIG. 5). Depending on the results of operation 412, method 400 may return to operation 406 or proceed to update (operation 414) the channel sets by moving one channel at a time to a channel set at a next lower power level. In other words, one channel may be moved in operation 414 from S_k to S_{k−1}. The channel sets may be updated by moving one channel at a time from the non-empty channel set corresponding to the largest power level so far, p_k, k=L, L−1, . . . , 2, to the one with p_{k−1}, which may increase the chance of more networks being included in the set corresponding to the lower power levels. Then, a decision may be made whether the channel set for power level=2 is empty (operation 416). When the result of operation 416 is NO, method 400 may return to operation 404. When the result of operation 416 is YES, singular network sets and channel sets may be output (operation 418) and method 400 may end (operation 410). For network set N_2, any remaining networks in operation 414 with a given value of Delta_{—}2 not included in N_{—}2 (because up to n_{—}2 networks/re-use pairs are already included) may be included in N_{—}1 corresponding to the channel set with the smallest power level (and hence maximum re-use possibility). However, if the number of channels in N_{—}1 is not enough (i.e., is less than \delta_{—}1+1), network splitting is not feasible and the current channel sets may be desirable for updating. When network splitting is not feasible, the S_{—}1 may represent the channel set of all available channels and N_{—}1 may represent the network set of all available networks, with all other channel sets and networks sets (for other values of l) remaining empty.

Turning now to FIG. 5, a block diagram of selected elements of an embodiment of method 500 for parallel white space resource management is shown in flow chart format. Method 500 may represent an embodiment of operation 412 described above with respect to method 400 (see FIG. 4). It is noted that certain operations depicted in method 500 may be rearranged or omitted, as desired. Method 500 may start with updating network sets from larger power levels. In particular, for N_l, networks with smaller Delta_l (starting from networks with Delta_l=0) may be included first, as discussed earlier. The number of networks included in N_l may depend on the number of available channels in S_l and the current maximum node degree of G_l. In order to provide a feasible channel assignment, for any value of Delta_l, up to n_l=|S_l|−\delta_l−1 networks/re-use pairs from the remaining network set (i.e. N\N_{—}1U . . . U N_L) will be included in network set N_l (and then \delta_l will be updated). For any network for a given value of Delta_l, method 500 may check if there are any other non-adjacent network(s). Then a network may be picked along with its re-use pairs (if applicable). Each re-use pair is counted as 1 group. Furthermore, higher priority may be given for including a re-use pair than a network. If multiple options (more than n_l) are available, the re-use pairs with minimum sum Delta_l may be chosen and finally break the ties, randomly.

Method 500 may begin by incrementing a counter i and setting l=k (operation 502). Then a decision may be made whether l>1 (operation 504) to start a loop. When the result of operation 504 is NO, method 500 may end the loop and proceed to operation 514 (described below). When the result of operation 504 is YES, method 500 may let n_l=|S_l|−\delta_l−1 (operation 506). Then a decision may be made whether n_l>0 (operation 508). When the result of operation 508 is YES, up to n_l re-use pairs and networks from the remaining network set (i.e. N\N_{—}1U . . . U N_L) with Delta_l=i in N_l may be selected (operation 510). After operation 510 or when the result of operation 508 is NO, l may be decremented (operation 512) and method 500 may return to operation 504. When the result of operation 504 is NO, method 500 may let n_{—}1=|S_{—}1|−\delta_{—}1−1 (operation 514). Then, a decision may be made whether n_{—}1>0 and a number of re-use pairs and networks with (Delta_{—}2=i)<=n_{—}1 (operation 516). When the result of operation 516 is NO, method 500 may return to operation 414 in method 400 (see FIG. 4). When the result of operation 516 is YES, re-use pairs and networks with (Delta_{—}2=i) may be included (operation 518) in N_{—}1, after which method 500 may return to operation 406 in method 400 (see FIG. 4).

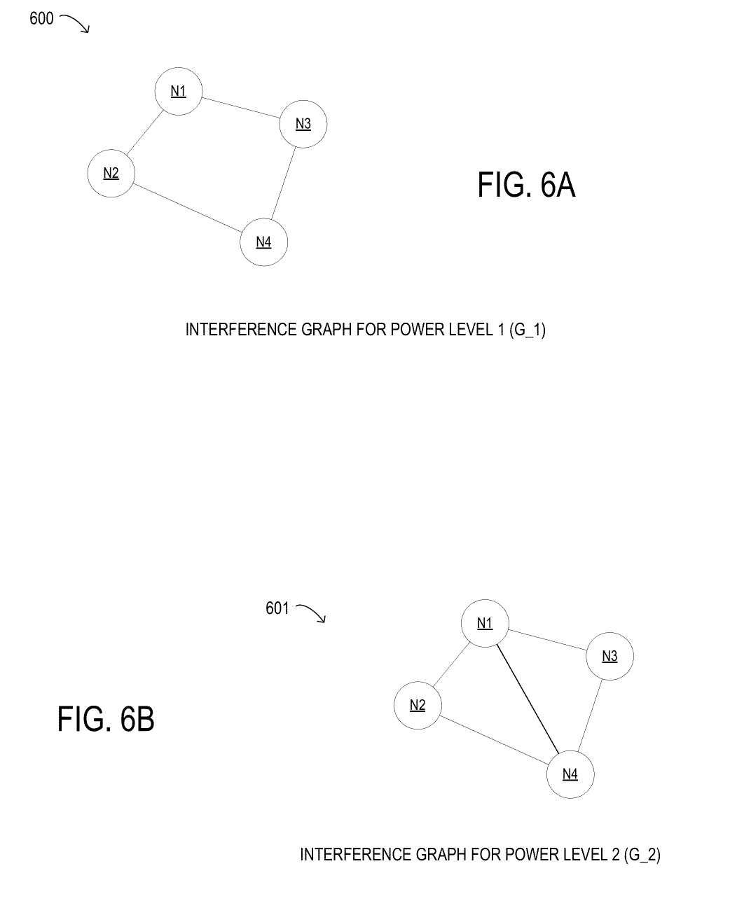

Turning now to FIGS. 6A and 6B, selected elements on an embodiment of an example of parallel white space resource management are shown. In the example of FIGS. 6A and 6B, the algorithm described above with respect to FIGS. 4 and 5 is applied to a topology of 4 networks (N1, N2, N3, and N4) assumed to share 3 white space channels (a, b, and c). In FIG. 6A, interference graph 600 shows the topology for power level 1 in graph G_{—}1, which corresponds to channels a and b at a power level 1 value of 40 mW. In FIG. 6B, interference graph 601 shows the topology for power level 2 in graph G_{—}2, which corresponds to channel c at a power level 2 value of 100 mW.

In one example, when no power control is employed (i.e., all channels transmit with 40 mW power level), in some cases, networks will get 10 MHz bandwidth and in some cases networks will get 5 MHz bandwidth (with the total utilization of 30 MHz). Hence, on average, every network may be allocated about 7.5 MHz bandwidth. Using the algorithm described herein, the following results may be obtained: S_{—}1={a, b}, S_{—}2={c}, N_{—}1={1,4} and N_{—}2={2,3}. It is noted that this algorithm generates the network sets and the corresponding channel sets, such that the channels from a channel set may be assigned to the corresponding network set. Various additional methods may then be used for channel assignment, as desired.

After channel assignment, for example, networks N2 and N3 may be assigned channel c at 100 mW power, while networks N1 and N4 may be assigned both channels a and b at 40 mW power. In an uncoordinated baseline policy, WiFi networks choose the channel with the least congestion, and LTE networks choose the channels with minimum interference level. It may be observed that, by utilizing more power levels along with coordinated orthogonal channel assignment, throughput performance may be significantly improved compared to the uncoordinated baseline policy and using no power control policies. In particular, it may be observed that, even though networks N2 and N3 (assumed to employ IEEE 802.11 access technology) are allocated larger average bandwidth in the uncoordinated baseline policy, the throughput performance of networks N2 and N3 is worse than the case with power control using the algorithm described herein, which allocates larger power but smaller bandwidth. For networks N1 and N4 (assumed to employ LTE access technology), it may be observed that throughput performance is also better using the methods described herein, since the allocated bandwidth for such cases remains at 10 MHz whereas using the uncoordinated baseline policy, networks N1 and N4 would get 5 MHz in some cases and 7.5 MHz on average.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for parallel resource management in white space bands, comprising:
receiving location information for N wireless networks sharing K channels in white space bands having L permissible power levels, wherein N and K are integers greater than or equal to 1;
generating, for each of the L power levels, an interference graph of the N wireless networks, the interference graph comprising nodes each corresponding to a wireless network and edges each corresponding to interference between two nodes, wherein a number of edges at each node represents a node degree, and L is an integer greater than or equal to 1;
initializing channel sets corresponding to the L power levels, beginning with channels having maximum power levels;
initializing network sets corresponding to the L power levels, including:
maximizing a number of networks in a maximum power network set corresponding to a maximum power level; and
emptying network sets other than the maximum power network set; and
updating the channel sets and the network sets, wherein a number of channels in a channel set corresponding to a network set is greater than a maximum node degree of the interference graph for a corresponding power level.

2. The method of claim 1, wherein updating the channel sets and the network sets includes:
based on the interference graphs for each of the L power levels, beginning updating network sets corresponding to channel sets with maximum power levels and adding, to the network sets, networks with minimum node degree change values.

3. The method of claim 1, wherein updating the channel sets and the network sets includes:
maximizing, in each network set, a number of networks corresponding to a channel set having larger power levels.

4. The method of claim 1, wherein updating the channel sets and the network sets includes:
prioritizing, in each network set, networks enabled to re-use channels already assigned to another network set.

5. The method of claim 1, further comprising:
outputting the channel sets and the network sets corresponding to the L power levels.

6. The method of claim 5, further comprising:
for each of the L power levels, assigning channels in the corresponding channel set to the networks in the corresponding network set.

7. The method of claim 1, wherein updating the channel sets and the network sets includes:
transferring one channel at a time to a channel set having a next lower power level.

8. An article of manufacture comprising:
a non-transitory, computer-readable medium; and
computer executable instructions stored on the computer-readable medium, the instructions readable by a processor and, when executed, for causing the processor to:
receive location information for N wireless networks sharing K channels in white space bands having L permissible power levels wherein N and K are integers greater than or equal to 1;
generate, for each of the L power levels, an interference graph of the N wireless networks, the interference graph comprising nodes each corresponding to a wireless network and edges each corresponding to interference between two nodes, wherein a number of edges at each node represents a node degree, and L is an integer greater than or equal to 1;
initialize channel sets corresponding to the L power levels, beginning with channels having maximum power levels;
initialize network sets corresponding to the L power levels, including instructions to:
maximize a number of networks in a maximum power network set corresponding to a maximum power level; and
empty network sets other than the maximum power network set; and
update the channel sets and the network sets, wherein a number of channels in a channel set corresponding to a network set is greater than a maximum node degree of the interference graph for a corresponding power level.

9. The article of manufacture of claim 8, wherein the instructions to update the channel sets and the network sets include instructions to:
based on the interference graphs for each of the L power levels, begin updating network sets corresponding to channel sets with maximum power levels and add, to the network sets, networks with minimum node degree change values.

10. The article of manufacture of claim 8, wherein the instructions to update the channel sets and the network sets include instructions to:
maximize, in each network set, a number of networks corresponding to a channel set having larger power levels.

11. The article of manufacture of claim 8, wherein the instructions to update the channel sets and the network sets include instructions to:
prioritize, in each network set, networks enabled to re-use channels already assigned to another network set.

12. The article of manufacture of claim 8, further comprising instructions for causing the processor to:
output the channel sets and the network sets corresponding to the L power levels.

13. The article of manufacture of claim 12, further comprising instructions for causing the processor to:
for each of the L power levels, assign channels in the corresponding channel set to the networks in the corresponding network set.

14. The article of manufacture of claim 8, wherein the instructions to update the channel sets and the network sets include instructions to:
transfer one channel at a time to a channel set having a next lower power level.
